(19) United States
(12) Patent Application Publication
(10) Pub. No.: US 2015/0029355 A1
(43) Pub. Date: Jan. 29, 2015

(54) IMAGE SENSORS AND IMAGING DEVICES INCLUDING THE SAME

(71) Applicant: Samsung Electronics Co., Ltd., Suwon-si (KR)

(72) Inventors: Se-jun Kim, Seoul (KR); Won-baek Lee, Suwon-Si (KR); Byung-jo Kim, Seoul (KR); Sung-ho Suh, Hwaseong-si (KR); Jin-ho Seo, Seoul (KR); Young-tae Jang, Pyeongtaek-si (KR); Seog-heon Ham, Suwon-si (KR); Jin-kyeong Heo, Hwaseong-si (KR)

(21) Appl. No.: 14/334,070

(22) Filed: Jul. 17, 2014

(30) Foreign Application Priority Data
Jul. 25, 2013 (KR) 10-2013-0088246

(51) Int. Cl. H04N 5/232

(52) U.S. Cl. CPC H04N 5/23229
USPC 348/222.1

(57) ABSTRACT

A pixel array includes pixels arranged in a grid, with separate readout paths configured to readout image data from different subsets of the pixels in the array. An image sensor may employ image data from one subset of pixels, which may include fewer pixels than another subset of pixels in the array, to quickly form an image.

### CROSS-REFERENCE TO RELATED APPLICATIONS

This application claims the benefit of Korean Patent Application No. 10-2013-0088246, filed on Jul. 25, 2013, in the Korean Intellectual Property Office, the disclosure of which is incorporated herein in its entirety by reference.

### BACKGROUND

Inventive concepts relate to image sensors and imaging devices including the same, and more particularly, to image sensors having pixel arrays and imaging devices including the same.

Image sensors for converting optical images into electrical signals have been widely used, not in only digital cameras, mobile phone cameras and portable camcorders, but also automobiles, security systems and robots, for example. Each image sensor may include a pixel array that may receive light through a module lens. The module lens may refract the light to focus the light on the pixel array in order to capture an image. Each pixel in the pixel array may include a photo detecting device, and the photo detecting device may receive the light to generate an electrical signal whose current or voltage varies according to the intensity of the light impinging upon the detecting device. For example, the photo detecting device may be a photo diode that generates a photo-current in response to received light.

The number of the pixels included in the pixel array may influence the resolution of the image sensor. That is, if the number of the pixels included in the pixel array increases, the resolution of the image sensor may be improved and the amount of data output from the image sensor may increase. As a result, if the number of the pixels included in the pixel array increases for high resolution, the data output time of the image sensor may increase and an image processor receiving data from the image sensor may require a relatively long period of time to process the data.

### SUMMARY

In various embodiments in accordance with principles of inventive concepts, image sensors and imaging devices including the same are provided.

In accordance with principles of inventive concepts, an image sensor a pixel array are configured to include a first group of pixels and a second group of pixels; a controller; a first signal path connected to the first group of pixels; a second signal path connected to the second group of pixels; and a read circuit configured to receive signals detected by the first group of pixels through the first signal path in response to a first path selection signal received from the controller and to receive signals detected by the second group of pixels through the second signal path in response to a second path selection signal received from the controller.

In accordance with principles of inventive concepts, the image sensor further comprises a first row driver configured to control the first group of pixels; and a second row driver configured to control the second group of pixels, wherein the read circuit comprises a first read circuit configured to receive signals detected by the first group of pixels through the first signal path and to output first data; a second read circuit configured to receive signals detected by the second group of pixels through the second signal path and to output second data, wherein the controller is configured to control the first and second row drivers such that the signals detected by the first group of pixels are input to the first read circuit during a first cycle time and the signals detected by the second group of pixels are input to the second read circuit during a second cycle time.

In accordance with principles of inventive concepts, an image sensor includes a first terminal and a second terminal, wherein the first and second read circuits are electrically connected to the first terminal and the second terminal, respectively; wherein the controller is configured to control the first read circuit such that the first data are output through the first terminal during the first cycle time; and wherein the controller is configured to control the second read circuit such that the second data are output through the second terminal during the second cycle time.

In accordance with principles of inventive concepts, a controller is configured to control the first row driver such that the first read circuit receives signals detected by a portion of the first group of pixels through the first signal path during the first cycle time.

In accordance with principles of inventive concepts, the portion of the first group of pixels is disposed in rows which are spaced apart from each other by a uniform distance, and the second group of pixels is disposed between the first group of pixels.

In accordance with principles of inventive concepts, each of the first and second group of pixels includes a plurality of organic photoelectric conversion layers, wherein the number of pixels included in the second group of pixels disposed between the first group of pixels along a row direction is equal to the number of pixels included in the second group of pixels disposed between the first group of pixels along a column direction.

In accordance with principles of inventive concepts, an image sensor includes a pixel array that further includes a color filter layer having a plurality of color filters which are arrayed in a Bayer pattern form; and the first group of pixels are two-dimensionally arrayed such that the color filters on respective ones of the first group of pixels are arrayed in the Bayer pattern form.

In accordance with principles of inventive concepts, the control block is configured to set the first and second cycle times in response to a command signal supplied from an external device.

In accordance with principles of inventive concepts, an image sensor includes a plurality of pixel units which are two-dimensionally disposed in a matrix direction, and configured to include a first group of pixels and a second group of pixels; a first signal path connected to the first group of pixels; a second signal path connected to the second group of pixels; and a control block, wherein the number of pixels included in the first group of pixels is greater than the number of pixels included in the second pixels. The control block includes a first row driver configured to control the first group of pixels; and a second row driver configured to control the second group of pixels.

In accordance with principles of inventive concepts, the control block further includes a controller; and a read circuit configured to receive signals detected by the first group of pixels through the first signal path in response to a first path selection signal received from the controller and to receive signals detected by the second group of pixels through the second signal path in response to a second path selection signal received from the controller.

In accordance with principles of inventive concepts, the read circuit includes a first read circuit configured to receive signals detected by the first group of pixels through the first signal path and to output first data; and a second read circuit configured to receive signals detected by the second group of pixels through the second signal path and to output second data.

In accordance with principles of inventive concepts, the controller is configured to control the first and second row drivers such that the signals detected by the first group of pixels are input to the first read circuit during a first cycle time and the signals detected by the second group of pixels are input to the second read circuit during a second cycle time.

In accordance with principles of inventive concepts, the image sensor further includes a first terminal; and a second terminal, wherein the control block is configured to output first data generated from signals detected by the first group of pixels through the first terminal and configured to output second data generated from signals detected by the second group of pixels through the second terminal.

In accordance with principles of inventive concepts, an portable electronic device includes an application processor; and an image sensor configured to generate image data. The image sensor includes a plurality of pixel units which are two-dimensionally disposed in a matrix direction, and configured to include a first group of pixels and a second group of pixels; a first signal path connected to the first group of pixels; a second signal path connected to the second group of pixels; a first row driver configured to control the first group of pixels; a second row driver configured to control the second group of pixels; a first terminal; a second terminal; and a control block configured to output first data generated from signals detected by the first group of pixels through the first terminal and configured to output second data generated from signals detected by the second group of pixels through the second terminal, wherein the number of pixels included in the first group of pixels is greater than the number of pixels included in the second group of pixels.

In accordance with principles of inventive concepts, the portable electronic device further includes an image processor connected with the image sensor, wherein the image processor is configured to receive the first data during a first cycle time and the second data during a second cycle time and is configured to generate first image data from the first data.

In accordance with principles of inventive concepts, the image processor synthesizes the first and second data to generate second image data during the second cycle time.

In accordance with principles of inventive concepts, an imaging device further comprises a memory device, wherein the image processor stores the second image data in the memory device.

In accordance with principles of inventive concepts, an imaging device further includes a viewfinder, wherein the viewfinder displays an image generated from the first image data during the first cycle time.

In accordance with principles of inventive concepts, the size of the first image data is smaller than the second image data.

In accordance with principles of inventive concepts, the image processor is configured to generate a command signal for setting the first and second cycle times and to apply the command signal to the image sensor; and wherein the control block is configured to output the first data during the first cycle time in response to the command signal and to output the second data during the second cycle time in response to the command signal.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram illustrating an imaging device including an image sensor in accordance with principles of inventive concepts;

FIG. 2 is a block diagram illustrating an image sensor in accordance with principles of inventive concepts;

FIG. 3 is an equivalent circuit diagram illustrating a pixel of an image sensor in accordance with principles of inventive concepts;

FIGS. 4A and 4B are plan views illustrating arrays of first group of pixels and second group of pixels included in image sensors according to some exemplary embodiments of the inventive concept;

FIG. 5A is a cross-sectional view illustrating a first pixel or a second pixel included in an image sensor in accordance with principles of inventive concepts;

FIG. 5B is a plan view illustrating an array of first group of pixels and second group of pixels included in an image sensor in accordance with principles of inventive concepts;

FIG. 6 is a block diagram illustrating an imaging device including an image processor and an image sensor in accordance with principles of inventive concepts;

FIGS. 7A and 7B are schematic diagrams illustrating operations of imaging devices according to some exemplary embodiments of the inventive concept;

FIG. 8 is a flowchart illustrating an operation of an image processor in accordance with principles of inventive concepts;

FIG. 9 is a block diagram illustrating a system including an image sensor in accordance with principles of inventive concepts; and

FIG. 10 is a block diagram of an electronic system including an image sensor in accordance with principles of inventive concepts.

### DESCRIPTION

Various exemplary embodiments will be described more fully hereinafter with reference to the accompanying drawings, in which exemplary embodiments are shown. Exemplary embodiments may, however, be embodied in many different forms and should not be construed as limited to exemplary embodiments set forth herein. Rather, these exemplary embodiments are provided so that this disclosure will be thorough, and will convey the scope of exemplary embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. The term “or” is used in an inclusive sense unless otherwise indicated.

It will be understood that, although the terms first, second, third, for example. may be used herein to describe various elements, components, regions, layers and/or sections, these elements, components, regions, layers and/or sections should not be limited by these terms. These terms are only used to distinguish one element, component, region, layer or section from another region, layer or section. In this manner, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. In this manner, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. In this manner, exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. In this manner, the regions illustrated in the figures are schematic in nature and their shapes are not intended to illustrate the actual shape of a region of a device and are not intended to limit the scope of exemplary embodiments.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments in accordance with principles of inventive concepts will be explained in detail with reference to the accompanying drawings.

If the number of pixels in a pixel array is increased to enhance the resolution of an image sensor, the time required for an image sensor to output pixel data and for an image processor to process image data may increase (if, for example, readout devices, clock speeds, and processors remain the same). In the extreme, the image processor may not be capable of updating image information at an adequate rate and, as a result, new image data may not be displayed, for example, on the viewfinder of an imaging device. Such a situation, a viewfinder that is not updated at an adequate rate, may be referred to as “black out.” Other functions, such as auto-focusing, may also be negatively impacted by the absence of updated data. In accordance with principles of inventive concepts, though, image data may be individually controlled, using different paths and, therefore, one path may be updated more frequently than another, allowing, for example, a viewfinder image or an autofocus image to be updated more frequently than image data being output to another destination, such as image storage.

Additionally, in accordance with principles of inventive concepts, an image processing system may process two subsets of the total number of pixels in an imaging device, and, with one of the subsets smaller than the other, may update a lower resolution image, using the smaller subset of pixels, more frequently than a higher resolution image. In exemplary embodiments in accordance with principles of inventive concepts, the more frequently updated image may be used, for example, by an auto-focus controller to rapidly focus an image or by a display controller to rapidly update a viewfinder display. In exemplary embodiments in accordance with principles of inventive concepts, lower resolution (that is, lower pixel count) and higher resolution (that is, higher pixel count) images may be combined to form a final image for display or storage, for example.

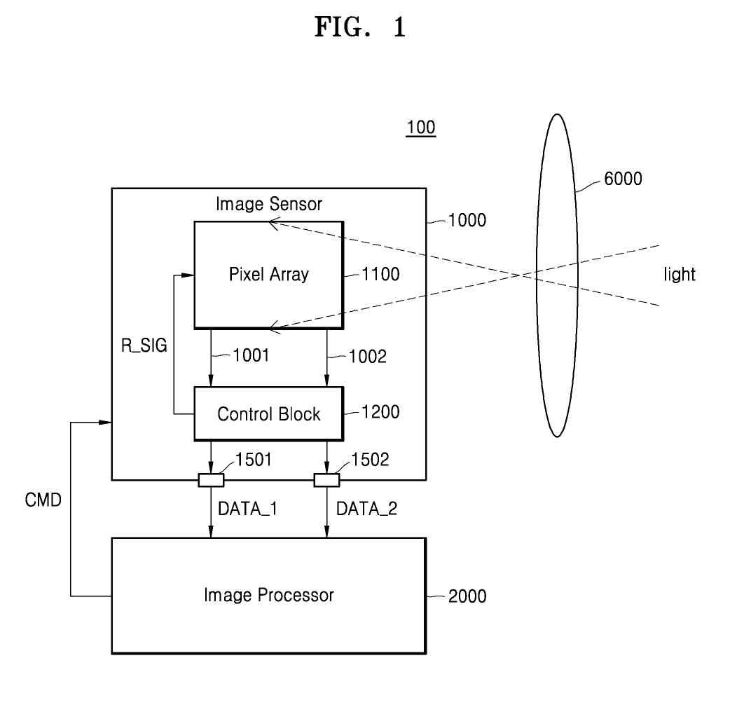

FIG. 1 is a block diagram illustrating an imaging device including an exemplary embodiment of an image sensor in accordance with principles of inventive concepts. The imaging device 100 may convert light into electrical signals to output image data and may include an image sensor 1000, an image processor 2000 and a module lens 6000, as illustrated in FIG. 1. The module lens 6000 may refract the light reflecting from external objects (or emanating from a light source) to focus the light on the image sensor 1000 in order to capture an image. The image sensor 1000 may receive the light penetrating the module lens 6000.

In some exemplary embodiments in accordance with principles of inventive concepts, the image sensor 1000 may include a pixel array 1100 and a control block 1200. In addition, the image sensor 1000 may also include a first terminal 1501 and a second terminal 1502 which may be electrically connected to an external device. The pixel array 1100 may include a plurality of pixel units which are two dimensionally disposed in a matrix direction and may receive the light penetrating the module lens 6000. In accordance with principles of inventive concepts pixel array 1100 may include a first group of pixels connected to a first signal path 1001 and a second group of pixels connected to a second signal path 1002, and may output electrical signals generated in the first and second group of pixels through the first and second signal paths 1001 and/or 1002. Levels of the electrical signals generated in the first and second group of pixels may depend on the intensity of the light, for example.

The control block 1200 may receive electrical signals output from the pixel array 1100 through the first and/or second signal paths 1001 and/or 1002. Control block 1200 may apply a row signal R_SIG to the pixel array 1100 to control an operation of the pixel array 1100. The control block 1200 may generate a first data DATA_{—}1 and a second data DATA_{—}2 based on the electrical signals output from the pixel array 1100 through the first and/or second signal paths 1001 and/or 1002 and may output the first and second data DATA_{—}1 and DATA_{—}2 through the first and second terminals 1501 and 1502. Each of the first and second terminals 1501 and 1502 may include a plurality of ports, and the first and second data DATA_{—}1 and DATA_{—}2 may be output through the plurality of ports.

The first data DATA_{—}1 and the second data DATA_{—}2 may be independently generated from the image sensor 1000, and the image sensor 1000 may be controlled by a command signal CMD output from the image processor 2000. For example, the output cycle time of the first and second data DATA_{—}1 and DATA_{—}2 may be controlled by the command signal CMD output from the image processor 2000. An exemplary embodiment of detailed operation in accordance with principles of inventive concepts of the image sensor 1000 for generating and outputting the first and second data DATA_{—}1 and DATA_{—}2 will be described later.

In exemplary embodiments in accordance with principles of inventive concepts, the image processor 2000 may receive the first and second data DATA_{—}1 and DATA_{—}2 which are output from the image sensor 1000 through the first and second terminals 1501 and 1502. The image processor 2000 may generate image data, or an image, based on the first and/or second data DATA_{—}1 and/or DATA_{—}2. For example, the image processor 2000 may generate image data, or an image, to be displayed on a viewfinder of the imaging device 100, based on the first data DATA_{—}1, and may generate image data, or an image, to be stored in a nonvolatile memory device of the imaging device 100, based on the first and second data DATA_{—}1 and DATA_{—}2.

Image processor 2000 may output the command signal CMD to control the image sensor 1000. The command signal CMD may include information for operation of the image sensor 1000. For example, the command signal CMD may include the information on the output cycle time of the first and second data DATA_{—}1 and DATA_{—}2. The image processor 2000 may further execute a post processing operation based on the first and second data DATA_{—}1 and DATA_{—}2. For example, the image processor 2000 may compensate for a lens shading effect or for colors of the image data.

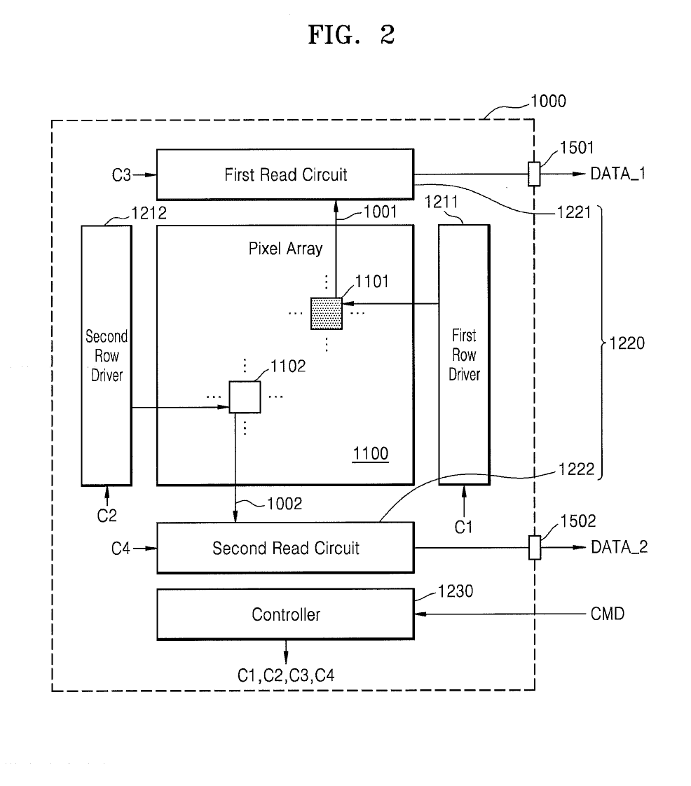

FIG. 2 is a block diagram illustrating an image sensor in accordance with principles of inventive concepts. As described above, the image sensor 1000 may output the first and second data DATA_{—}1 and DATA_{—}2 in response to the command signal CMD supplied from the image processor 2000. As illustrated in FIG. 2, the image sensor 1000 may include the pixel array 1100, the control block 1200, the first terminal 1501 and the second terminal 1502. The control block 1200 may include a first row driver 1211, a second row driver 1212, a read circuit 1220, and a controller 1230. The read circuit may include a first read circuit 1221 and a second read circuit 1222.

In exemplary embodiments in accordance with principles of inventive concepts, the pixel array 110 may include first and second group of pixels 1101 and 1102. Although FIG. 2 illustrates a single first pixel 1101 and a single second pixel 1102, the pixel array 110 may include a plurality of first group of pixels 1101 and a plurality of second group of pixels 1102. In the following exemplary embodiments, it is assumed that the number of pixels included in the first group of pixels 1101 is less than the number of pixels included in the second group of pixels 1102.

The first group of pixels 1101 may be controlled by the first row driver 1211. The first group of pixels 1101 may be electrically connected to the first signal path 1001, and electrical signals generated in the first group of pixels 1101 in response to the light may be transmitted to the first read circuit 1221 through the first signal path 1001. Similarly, the second group of pixels 1102 may be controlled by the second row driver 1212 and may be electrically connected to the second signal path 1002. Accordingly, electrical signals generated in the second group of pixels 1102 in response to the light may be transmitted to the second read circuit 1222 through the second signal path 1002.

In exemplary embodiments in accordance with principles of inventive concepts, the first row driver 1211 and the second row driver 1212 may control the first group of pixels 1101 and second group of pixels 1102, respectively. For example, photo detecting devices included in the first group of pixels 1101 may receive light to generate the electrical signals, and the first row driver 1211 may control the first group of pixels 1101 such that the electrical signals generated from the first group of pixels 1101 are output through the first signal path 1001. Similarly, the second row driver 1212 may control the second group of pixels 1102 such that electrical signals generated from the second group of pixels 1102 are output through the second signal path 1002. As described above, the first row driver 1211 and the second row driver 1212 may control the first group of pixels 1101 and second group of pixels 1102, respectively. As a result, in accordance with principles of inventive concepts, the first group of pixels 1101 and second group of pixels 1102 may independently operate. For example, a point of time that the first group of pixels 1101 receive the light may be different from a point of time that the second group of pixels 1102 receive the light, and a point of time that the electrical signals generated in the first group of pixels 1101 are output may be different from a point of time that the electrical signals generated in the second group of pixels 1102 are output.

In exemplary embodiments in accordance with principles of inventive concepts, the first read circuit 1221 may receive the electrical signals output from the first group of pixels 1101, and the second read circuit 1222 may receive the electrical signals output from the second group of pixels 1102. The electrical signals output from the first and second group of pixels 1101 and 1102 may include analog signals, and the first and second read circuits 1221 and 1222 may covert the analog signals output from the first and second group of pixels 1101 and 1102 into digital signals (that is, digital data). For example, each of the first and second read circuits 1221 and 1222 may include an analog-to-digital converter (ADC), and the electrical signals output from the first and second group of pixels 1101 and 1102 may be transmitted to the ADCs of the first and second read circuits 1221 and 1222. Additionally, each of the first and second read circuits 1221 and 1222 may include a buffer that temporarily stores the digital data which are output from the ADC of the first or second read circuit 1221 or 1222.

In exemplary embodiments in accordance with principles of inventive concepts, the first read circuit 1221 and the second read circuit 1222 may output the first data DATA_{—}1 and the second data DATA_{—}2, respectively. The first data DATA_{—}1 may be generated from the output signals of the first group of pixels 1101 and the second data DATA_{—}2 may be generated from the output signals of the second group of pixels 1102. That is, the first data DATA_{—}1 may include digital data stored in the buffer of the first read circuit 1221, and the second data DATA_{—}2 may include digital data stored in the buffer of the second read circuit 1222.

Because, in exemplary embodiments in accordance with principles of inventive concepts, the first group of pixels 1101 and the second group of pixels 1102 are separately controlled by the first row driver 1211 and the second row driver 1212, the first read circuit 1221 and the second read circuit 1222 may be operated independently. For example, the first read circuit 1221 may receive electrical signals which are output from the first group of pixels 1101 at a first moment, and the second read circuit 1222 may receive electrical signals which are output from the second group of pixels 1102 at a second moment earlier or later than the first moment. In this manner, in accordance with principles of inventive concepts. As a result, the point of time at which the first data DATA_{—}1 is output from the first read circuit 1221 may be different from the point of time at which the second data DATA_{—}2 is output from the second read circuit 1221.

As illustrated in FIG. 2, the first data DATA_{—}1 generated by the first read circuit 1221 may be transmitted to an external device through the first terminal 1501 and the second data DATA_{—}2 generated by the second read circuit 1222 may be transmitted to an external device through the second terminal 1502. As described with reference to FIG. 1, in accordance with principles of inventive concepts, the image processor 2000 may receive the first and second data DATA_{—}1 and DATA_{—}2 generated by the first and second read circuits 1221 and 1222 through the first and second terminals 1501 and 1502.

The controller 1230 may receive the command signal CMD supplied from an external device that is separated from the image sensor 1000, for example, and may control the first and second row drivers 1211 and 1212 and the first and second read circuits 1221 and 1222 in response to the command signal CMD. As illustrated in FIG. 2, the controller 1230 may output first to fourth control signals C1, C2, C3 and C4, and the first to fourth control signals C1, C2, C3 and C4 may be transmitted to the first row driver 1211, the second row driver 1212, the first read circuit 1221 and the second read circuit 1222, respectively. As described with reference to FIG. 1, the command signal CMD may be output from the image processor 2000.

In exemplary embodiments in accordance with principles of inventive concepts, the command signal CMD may include information related to the output cycle time of the first and second data DATA_{—}1 and DATA_{—}2 generated by the first and second read circuits 1221 and 1222. That is, the command signal CMD may include information related to a first cycle time corresponding to the output cycle time of the first data DATA_{—}1 generated by the first read circuit 1221 and to a second cycle time corresponding to the output cycle time of the second data DATA_{—}2 generated by the second read circuit 1222. According to the information on the first and second cycle times included in the command signal CMD, the controller 1230 may control the first and second row drivers 1211 and 1212 using the control signals C1 and C2 such that the first group of pixels 1101 periodically receive the light to generate electrical signals according to a first cycle time and the second group of pixels 1102 periodically receive the light to generate electrical signals according to a second cycle time. In accordance with principles of inventive concepts, the controller 1230 may control the first and second read circuits 1221 and 1222 using the control signals C3 and C4 such that the first read circuit 1221 periodically receives the electrical signals output from the first group of pixels 1101 to output the first data DATA_{—}1 according to the first cycle time and the second read circuit 1222 periodically receives the electrical signals output from the second group of pixels 1102 to output the second data DATA_{—}2 according to the second cycle time. The control signals C3 and C4 may be referred to a first path selection signal and a second path selection signal respectively. That is, the first group of pixels 1101 may periodically generate the electrical signals in response to the light on the first cycle time and may periodically output the electrical signals through the first signal path 1001 on the first cycle time. In accordance with principles of inventive concepts, the first read circuit 1221 may periodically receive the electrical signals output from the first group of pixels 1101 on the first cycle time and may periodically output the first data DATA_{—}1 generated from the electrical signals on the first cycle time. Similarly, the second group of pixels 1102 may periodically generate the electrical signals in response to the light on the second cycle time and may periodically output the electrical signals through the second signal path 1002 on the second cycle time. In accordance with principles of inventive concepts, the second read circuit 1222 may periodically receive the electrical signals output from the second group of pixels 1102 on the second cycle time and may periodically output the second data DATA_{—}2 generated from the electrical signals on the second cycle time. A reciprocal number of the first cycle time or the second cycle time may be referred to herein as a frame rate, or first or second frame rate, respectively.

If the number of the pixels receiving light increases, the number of the electrical signals output from the pixels may also increase. In such a case, the amount of the data output from the image sensor 1000 may also increase. In exemplary embodiments in accordance with principles of inventive concepts, the pixel array 1100 may include the plurality of first group of pixels 1101 and the plurality of second group of pixels 1102, and the controller 1230 may control the first and second row drivers 1211 and 1212 such that the first group of pixels 1101 are simultaneously exposed to the light and the second group of pixels 1102 are simultaneously exposed to the light. The amount of the first data DATA_{—}1 generated by the electrical signals output from the first group of pixels 1101 may be less than the amount of the second data DATA_{—}2 generated by the electrical signals output from the second group of pixels 1102. In accordance with principles of inventive concepts, the first data DATA_{—}1 may therefore be more frequently generated and output than the second data DATA_{—}2. That is, the first cycle time may be shorter than the second cycle time.

In exemplary embodiments in accordance with principles of inventive concepts, the imaging device 100 may utilize the first data DATA_{—}1 more frequently output from the image sensor 1000 as data for displaying on the viewfinder, thereby improving the image update speed (or a frame rate) of the viewfinder. Additionally, in accordance with principles of inventive concepts, the imaging device 100 may employ the more-frequently updated image data DATA_{—}1 to rapidly determine whether the light reflected from the object is well focused on the pixel array 1100.

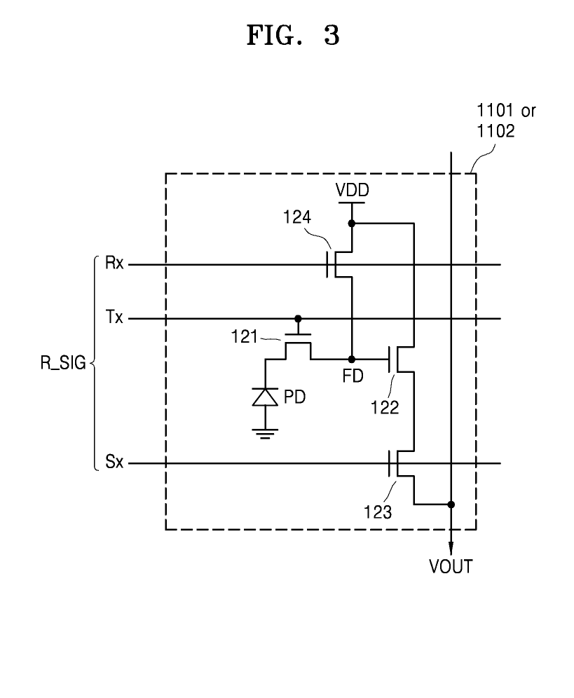

FIG. 3 is an equivalent circuit diagram illustrating a pixel of an image sensor in accordance with principles of inventive concepts. In exemplary embodiments in accordance with principles of inventive concepts, each of the first group of pixels 1101 shown in FIG. 2 may have substantially the sane structure as each of the second group of pixels 1102 shown in FIG. 2. Thus, the operation and configuration of an exemplary embodiment in accordance with principles of inventive concepts of one pixel of the first and second group of pixels 1101 and 1102 will be described hereinafter.

Referring to FIGS. 2 and 3, the pixel 1101 or 1102 may receive a row signal R_SIG supplied from the first or second row driver 1211 or 1212 to output an output voltage signal VOUT which is applied to the first or second read circuit 1221 or 1222. The row signal R_SIG may be applied to all the pixels in a single row, and all the pixels in a single column may be electrically connected to the first or second read circuit 1221 or 1222 through a single signal line. In exemplary embodiments in accordance with principles of inventive concepts, even though the first and second group of pixels 1101 and 1102 are located in a single column, the first and second group of pixels 1101 and 1102 in a single column may not share a single signal line. As a result, at least one of the first group of pixels 1101 in a single row may generate at least one output voltage signal VOUT in response to the row signal R_SIG, and the at least one output voltage signal VOUT may be transmitted to the first read circuit 1221. If two or more first group of pixels 1101 in a single row are selected to generate the output voltage signals VOUT, the output voltage signals VOUT generated from the selected first group of pixels 1101 may be simultaneously transmitted to the first read circuit 1221. The output voltage signals VOUT of the first group of pixels 1101 may be sequentially transmitted to the first read circuit 1221 row by row.

The row signal R_SIG may include a reset signal Rx, a transfer signal Tx and a selection signal Sx, and the reset signal Rx, the transfer signal Tx and the selection signal Sx may be applied to gates of various transistors constituting the first pixel 1101. The level of each output voltage signal VOUT may be determined according to the intensity of light that is irradiated on the corresponding first pixel 1101.

As illustrated in FIG. 3, the first pixel 1101 (or the second pixel 1102) may include a photo detecting device PD, a transfer transistor 121, a source-follower transistor 122, a selection transistor 123 and a reset transistor 124. In accordance with principles of inventive concepts, the first pixel 1101 may include a floating diffusion region FD corresponding to a node which is commonly connected to the transfer transistor 121, the source-follower transistor 122 and the reset transistor 124.

The photo detecting device PD may receive light to generate electric signals whose amount varies according to an intensity of the light. For example, the photo detecting device PD may be a photo diode, a photo gate or a photo transistor. Although FIG. 3 illustrates an example in which the photo detecting device PD is a photo diode, inventive concepts are not limited thereto.

Transfer transistor 121 may receive the transfer signal Tx to transfer the charges stored in the photo detecting device PD to the floating diffusion region FD or to prevent the charges stored in the photo detecting device PD from being transferred to the floating diffusion region FD. For example, while the photo detecting device PD receives the light to generate electric charges, the transfer signal Tx for turning off the transfer transistor 121 may be applied to the gate of the transfer transistor 121. In accordance with principles of inventive concepts, after light is blocked to terminate generation of the charges in the photo detecting device PD, the transfer signal Tx for turning on the transfer transistor 121 may be applied to the gate of the transfer transistor 121.

The source-follower transistor 122 may amplify a voltage signal of the floating diffusion region FD, and the selection transistor 123 may selectively output the amplified voltage signal. The reset transistor 124 may receive the reset signal Rx to electrically connect the floating diffusion region FD to a power voltage VDD terminal or to electrically disconnect the floating diffusion region FD from the power voltage VDD terminal. For example, in an initialization mode, the reset transistor 124 may be turned on in response to the reset signal Rx to drive the floating diffusion region FD to the level of the power voltage VDD. In accordance with principles of inventive concepts, the first pixel 1101 may amplify an electrical signal generated from the charges stored in the photo detecting device PD. As a result, the first pixel 1101 may be referred to as an active pixel sensor (APS). In accordance with principles of inventive concepts, the first or second pixel 1101 or 1102 illustrated in FIG. 3 may be embodied in many different forms.

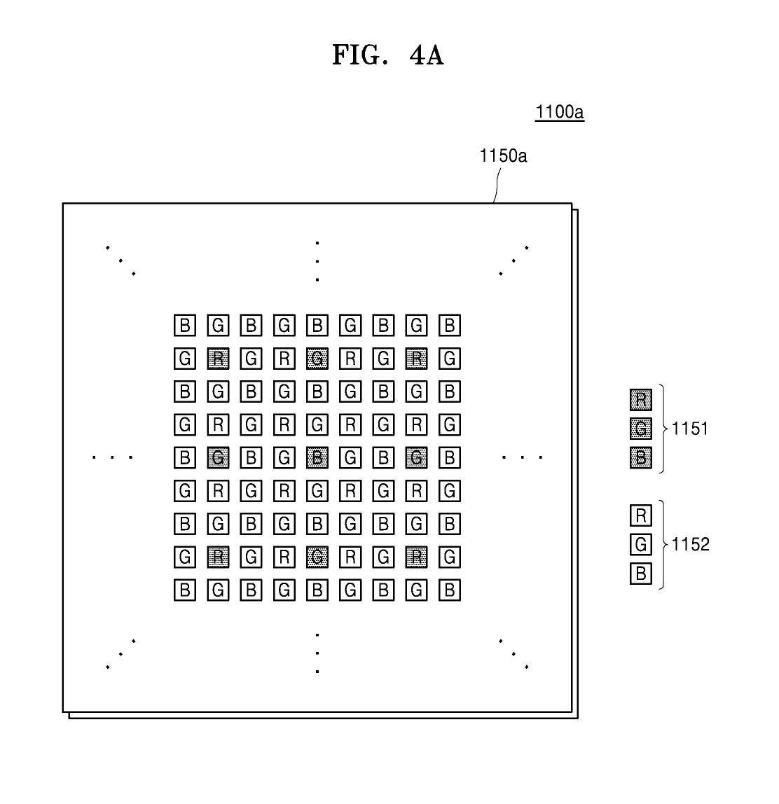

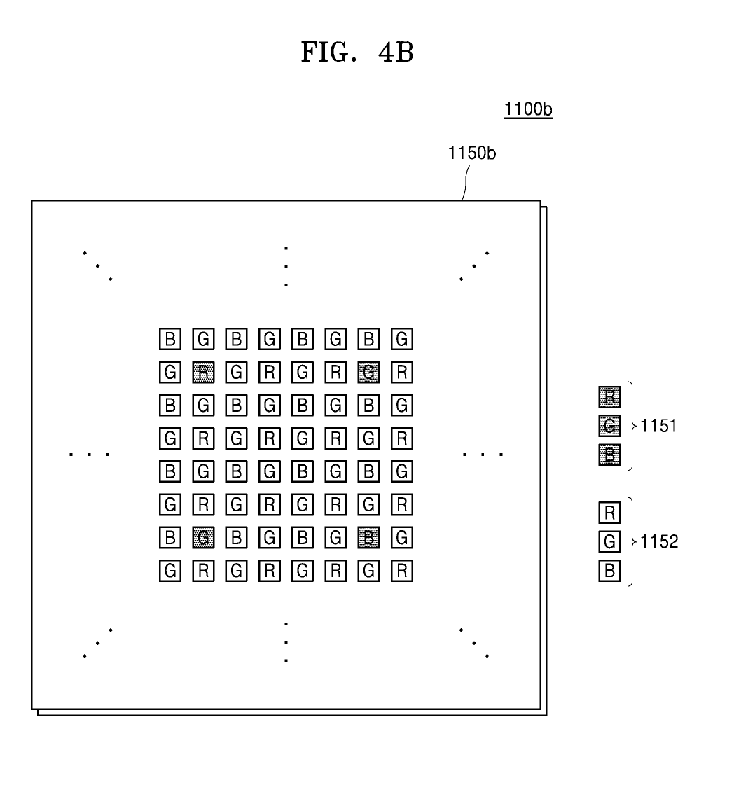

FIGS. 4A and 4B are plan views illustrating arrays of first group of pixels and second group of pixels included in image sensors according to some exemplary embodiments in accordance with principles of inventive concepts. As illustrated in FIGS. 4A and 4B, a pixel array 1100a or 1100b may include a color filter layer 1150a or 1150b. The color filter layer 1150a or 1150b may be disposed between the module lens 6000 (see FIG. 1) and the first and second group of pixels 1101 and 1102, for example. Light irradiated on the image sensor 1000 through the module lens 6000 may penetrates the color filter layer 1150a or 1150b to reach the pixels. The color filter layer 1150a or 1150b may include first color filters 1151 disposed on or, over, the first group of pixels 1101 and second color filters 1152 disposed on or, over, the second group of pixels 1102, and each of the first and second color filters 1151 and 1152 may pass only a light having a specific wavelength, or range of wavelengths, therethrough. For example, as illustrated in FIGS. 4A and 4B, the color filter layer 1150a or 1150b may include three different color filters R, G and B, and each of the color filters R, G and B may selectively pass any one of a red light, a green light and a blue light therethrough. Each of the photo detecting devices PD constituting the first and second group of pixels 1101 and 1102 may generate electric charges whose amount varies according to the intensity of received light. As a result, the plurality of the photo detecting devices PD may receive various lights having different wavelengths to generate electrical signals, and the imaging device 100 including the plurality of the photo detecting devices PD may output color images based on the electrical signals.

In exemplary embodiments in accordance with principles of inventive concepts, the color filter layer 1150a or 1150b may include a plurality of color filters R, G and B arrayed using a Bayer pattern. A unit pattern of the Bayer pattern may include a 50% green color filter, a 25% red color filter and a 25% blue color filter. For example, as illustrated in FIGS. 4A and 4B, the unit pattern of the Bayer pattern may include four color filters disposed in a rectangular area, and the four color filters constituting the unit pattern of the Bayer pattern may include two green color filters G, one red color filter R and one blue color filter B.

In exemplary embodiments in accordance with principles of inventive concepts, as described above, the amount of the first data DATA_{—}1 obtained by processing the electrical signals output from the first group of pixels 1101 may be relatively less than the amount of the second data DATA_{—}2. As a result, the first data DATA_{—}1 may be more quickly generated than the second data DATA_{—}2; the image processor 2000 may also quickly process the first data DATA_{—}1 to generate the image data; and the image data may be displayed on the viewfinder of the imaging device 100 or may be used to execute an auto-focusing function at a higher rate than second data DATA_{—}2 may be generated and processed. The number of pixels included in the first group of pixels 1101 and the number of pixels included in the second group of pixels 1102 may be determined according to a resolution of the viewfinder or according to the needs of the auto-focusing function, for example.

FIG. 4A illustrates an array of the first and second group of pixels according to an exemplary embodiment in accordance with principles of inventive concepts. Referring to FIGS. 2 and 4A, the first group of pixels 1101 may be arrayed to correspond to the first color filters 1151 of the color filter layer 1150a and the second group of pixels 1102 may be arrayed to correspond to the second color filters 1152 of the color filter layer 1150a. For example, as illustrated in FIG. 4A, the array of the first and second color filters 1151 and 1152 may include a plurality of unit arrays which are two dimensionally arrayed along row and columns, and each of the unit arrays may include a single first color filter 1151 and eight second color filters 1152 surrounding the single first color filter 1151. The first color filters 1151 may be disposed on respective ones of the first group of pixels 1101, and the second color filters 1152 may be disposed on respective ones of the second group of pixels 1102.

In exemplary embodiments in accordance with principles of inventive concepts, when the color filters 1151 and 1152 are arrayed to have the Bayer pattern form, the first color filters 1151 may also be independently arrayed to have the Bayer pattern form. For example, as illustrated in FIG. 4A, a unit array of the first color filters 1151 may include a 50% green color filter, a 25% red color filter and a 25% blue color filter.

FIG. 4B illustrates an array of the first and second group of pixels according to another exemplary embodiment in accordance with principles of inventive concepts. Referring to FIGS. 2 and 4B, the first group of pixels 1101 may be arrayed to correspond to the first color filters 1151 of the color filter layer 1150b and the second group of pixels 1102 may be arrayed to correspond to the second color filters 1152 of the color filter layer 1150b. Unlike the array illustrated in FIG. 4A, a unit array of the first and second color filters 1151 and 1152 illustrated in FIG. 4B may include a single first color filter 1151 and twenty-four second color filters 1152 adjacent to the single first color filter 1151. The first color filters 1151 may be disposed on respective ones of the first group of pixels 1101, and the second color filters 1152 may be disposed on respective ones of the second group of pixels 1102. As illustrated in FIG. 4B, the color filters 1151 and 1152 may be arrayed to have the Bayer pattern form, and the first color filters 1151 may also be independently arrayed to have the Bayer pattern form.

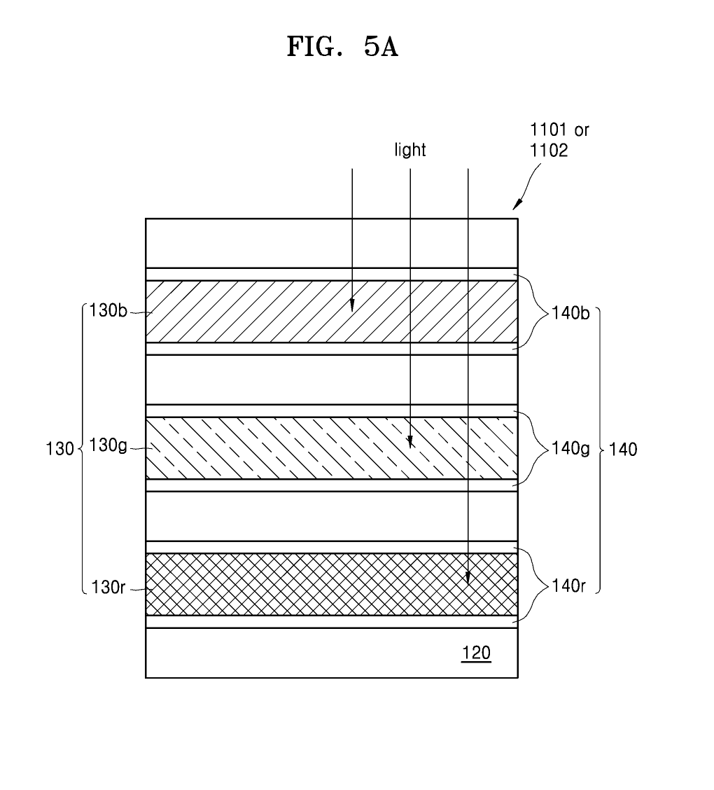

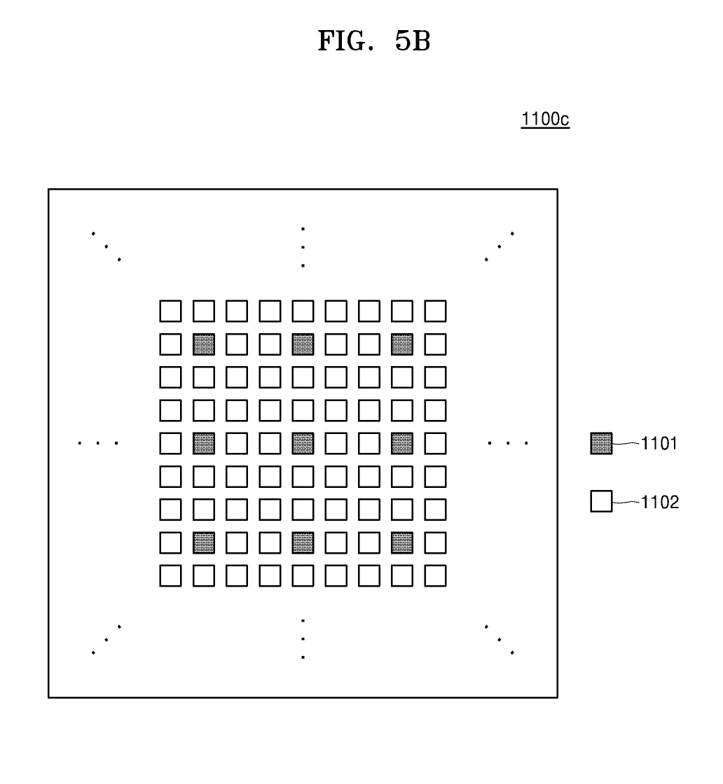

FIG. 5A is a cross-sectional view illustrating a first pixel or a second pixel included in an image sensor in accordance with principles of inventive concepts, and FIG. 5B is a plan view illustrating an array of first group of pixels and second group of pixels included in an image sensor in accordance with principles of inventive concepts. Each of the first and second group of pixels 1101 and 1102 illustrated in FIGS. 5A and 5B may include a plurality of organic photoelectric conversion layers, and the image sensor including the organic photoelectric conversion layers may be referred to as an organic image sensor. The plurality of organic photoelectric conversion layers of each pixel may be stacked in a direction that is parallel with an incident light. For example, each pixel of the organic image sensor may include first to third organic photoelectric conversion layers that are sequentially stacked. In such embodiments, the first organic photoelectric conversion layer may generate an electrical signal in response to light having a wave length corresponding to a red color, and the second organic photoelectric conversion layer may generate an electrical signal in response to light having a wave length corresponding to a green color, and the third organic photoelectric conversion layer may generate an electrical signal in response to light having a wave length corresponding to a blue color.

As illustrated in FIG. 5A, in exemplary embodiments in accordance with principles of inventive concepts, the first pixel 1101 (or the second pixel 1102) may include a plurality of stacked organic photoelectric conversion layers 130, for example, a first organic photoelectric conversion layer 130r absorbing light having a red color wavelength to generate electric charges, a second organic photoelectric conversion layer 130g absorbing light having a green color wavelength to generate electric charges, and a third organic photoelectric conversion layer 130b absorbing light having a blue color wavelength to generate electric charges. A first charge storage layer 140r may be disposed to cover a top surface and a bottom surface of the first organic photoelectric conversion layer 130r, and a second charge storage layer 140g may be disposed to cover a top surface and a bottom surface of the second organic photoelectric conversion layer 130g. A third charge storage layer 140b may be disposed to cover a top surface and a bottom surface of the third organic photoelectric conversion layer 130b. The first to third charge storage layers 140r, 140g and 140b may constitute a charge storage layer 140, and the charge storage layer 140 may accumulate or store the electric charges generated in the organic photoelectric conversion layers 130. In exemplary embodiments in accordance with principles of inventive concepts, charges accumulated in each of the first to third charge storage layers 140r, 140g and 140b may be transmitted to a transistor formed on a substrate 120 through a conductive line coupled between the corresponding charge storage layer and the transistor.

As illustrated in FIG. 5B, in exemplary embodiments in accordance with principles of inventive concepts, a pixel array 1100c may include the first group of pixels 1101 and the second group of pixels 1102. The pixel array 1100c may include a plurality of unit arrays which are two dimensionally arrayed along row and columns, and the unit array of the pixel array 1100c may include a single first pixel 1101 and eight second group of pixels 1102 disposed to surround the single first pixel 1101.

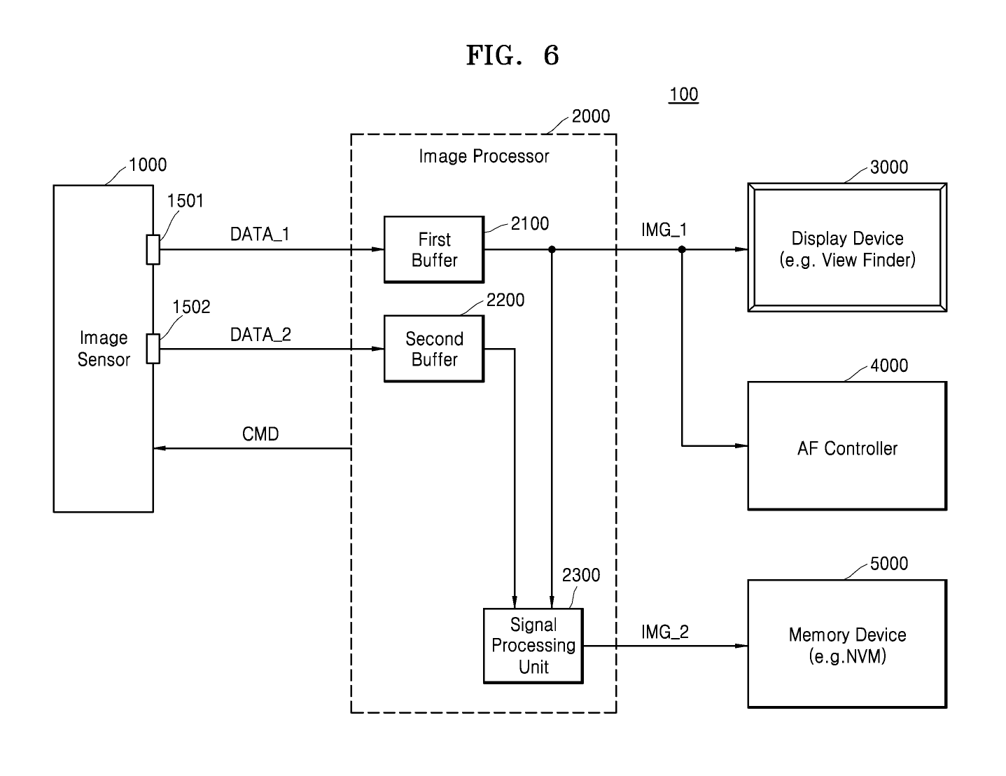

FIG. 6 is a block diagram illustrating an exemplary embodiment of an imaging device including an image processor and an image sensor in accordance with principles of inventive concepts. As illustrated in FIG. 6, the imaging device 100 may include an image sensor 1000, an image processor 2000, a display unit 3000, an auto-focus controller 4000 and a memory device 5000. As described with reference to FIGS. 1 and 2, the image sensor 1000 may output the first data DATA_{—}1 and the second data DATA_{—}2 in response to the command signal CMD supplied from the image processor 2000. The first data DATA_{—}1 and the second data DATA_{—}2 may be output through the first terminal 1501 and the second terminal 1502, respectively.

The image processor 2000 may receive the first and second data DATA_{—}1 and DATA_{—}2 and may output the command signal CMD. In accordance with principles of inventive concepts, the image processor 2000 may process the first data DATA_{—}1 to generate a first image data IMG_{—}1 and may process the first and second data DATA_{—}1 and DATA_{—}2 to generate a second image data IMG_{—}2. In accordance with principles of inventive concepts, second image data IMG_{—}2 may be generated based on electrical signals output from all the pixels (that is, the first and second group of pixels 1101 and 1102) of the pixel array 1100 in the image sensor 1000 and first image data IMG_{—}1 may be generated based on electrical signals from a subset of pixels (for example, first group of pixels 1101) of the pixel array 1100 in the image sensor 1000.

As illustrated in the exemplary embodiment of FIG. 6, the image processor 2000 may include a first buffer 2100, a second buffer 2200 and a signal processing unit 2300. The first and second buffers 2100 and 2200 may store the first and second data DATA_{—}1 and DATA_{—}2, respectively. The first data DATA_{—}1 may be sequentially output in a predetermined amount of data. In exemplary embodiments in accordance with principles of inventive concepts, the predetermined amount of data may correspond to the amount of data obtained by processing the electrical signals output from all the first group of pixels 1101 in a single row of the pixel array 1100. The image processor 2000 may store the first data DATA_{—}1 sequentially output from the image sensor 1000 in the first buffer 2100. The second data DATA_{—}2 may also be sequentially output in a predetermined amount of data, and the image processor 2000 may store the second data DATA_{—}2 sequentially output from the image sensor 1000 in the second buffer 2200.

The signal processing unit 2300 may process the data output from the first and second buffers 2100 and 2200 to generate the second image data IMG_{—}2. The second data DATA_{—}2 may be generated without using the electrical signals output from the first group of pixels 1101. As a result, the signal processing unit 2300 may synthesize, or combine, the data stored in the first buffer 2100 and the data stored in the second buffer 2200 to generate the second image data IMG_{—}2 in order to provide an image that includes data from all the pixels in the array 1100. In accordance with principles of inventive concepts, the signal processing unit 2300 may execute post-processing functions such as brightness compensation and/or color compensation, and the second image data IMG_{—}2 may correspond to the post-processed data. The signal processing unit 2300 may transmit the second image data IMG_{—}2 to the memory device 5000, and the memory device 5000 may store the second image data IMG_{—}2 therein. The memory device 5000 may include a nonvolatile memory (NVM) device that retains their stored data even when their power supplies are interrupted, for example.

In exemplary embodiments in accordance with principles of inventive concepts, display unit 3000 may receive the first image data IMG_{—}1 output from the image processor 2000 and may display the image generated from the first image data IMG_{—}1. The display unit 3000 may be used to allow users to verify the image is an object of interest, with the display unit 3000 being a viewfinder, for example. In exemplary embodiments in accordance with principles of inventive concepts, the resolution of the display unit 3000 may be lower than the resolution of the pixel array 1100 in the image sensor 1000 (lower, that is, than the resolution provided by using all pixels in the image sensor 1000). As a result, the image of the object may be displayed on the display unit 3000 using only the first image data IMG_{—}1 generated from the electrical signals output from the first group of pixels 1101 among the entire pixels of the pixel array 1100. As described above, the image sensor 1000 may therefore output the first data DATA_{—}1 at a high speed, and the image processor 2000 may generate the first image data IMG_{—}1 in response to the first data DATA_{—}1 at a high speed. As a result, the display unit 3000 may allow the user to verify the image of the object quickly, which may be very useful, for example, in a situation where the object or the imaging device 100 moves quickly.

In accordance with principles of inventive concepts, auto-focus controller 4000 may receive the first image data IMG_{—}1 output from the image processor 2000 to optimize a focus of the image of the object based on the first image data IMG_{—}1. That is, the auto-focus controller 4000 may analyze the first image data IMG_{—}1 to recognize a focus status of the image and may move the module lens 6000 (see FIG. 1) to optimize the focus of the image of the object quickly.

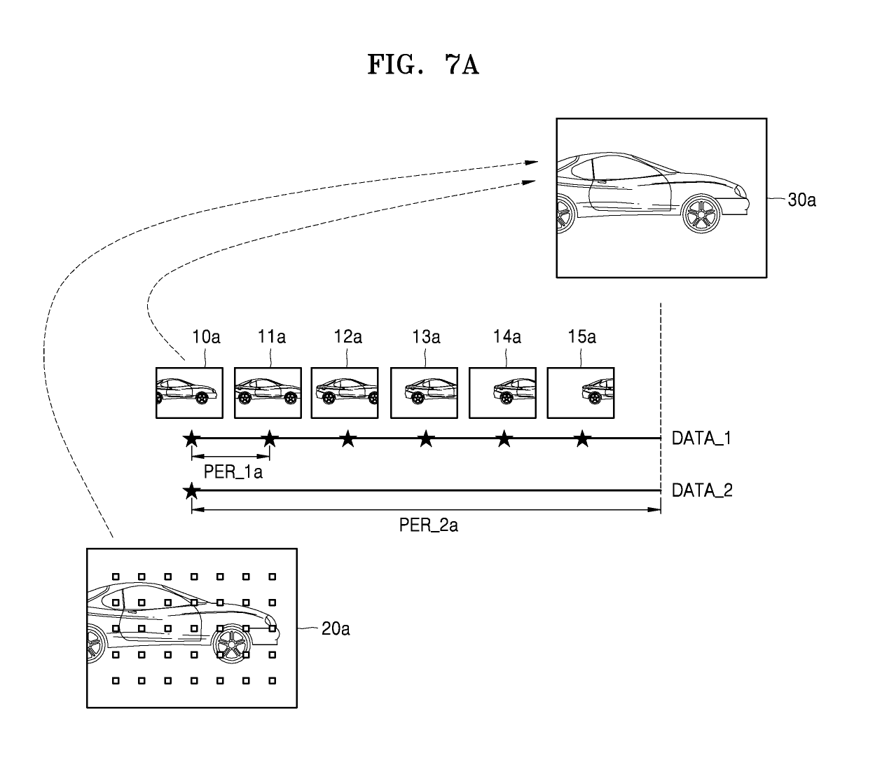

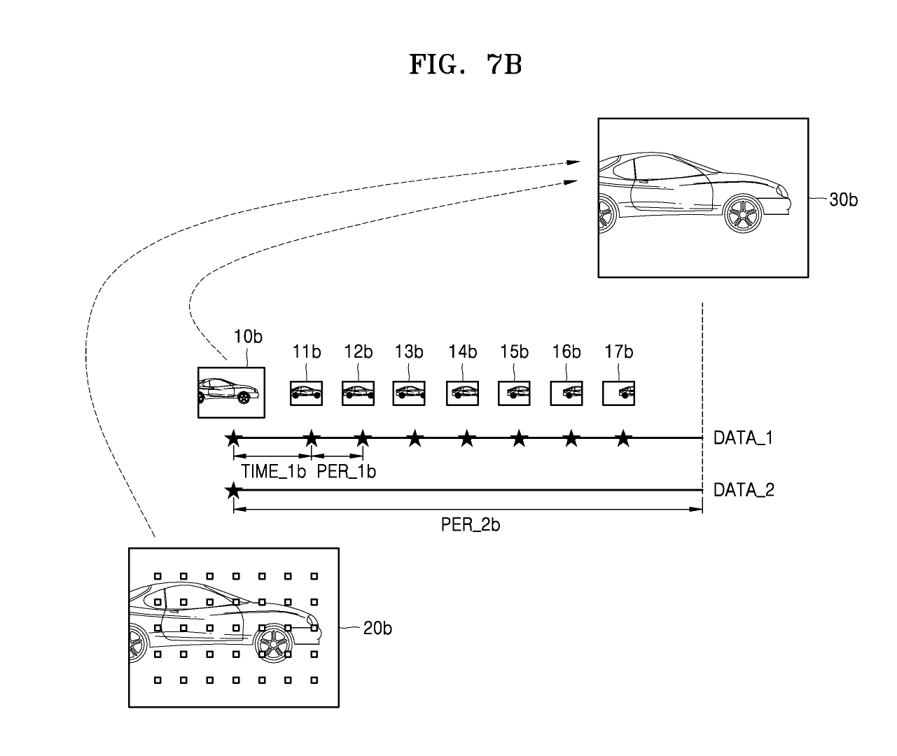

FIGS. 7A and 7B are schematic diagrams illustrating exemplary embodiments of the operation of an imaging device in accordance with principles of inventive concepts. In particular, FIGS. 7A and 7B illustrate operations of the imaging device 100 when the imaging device 100 takes pictures of an object (for example, an automobile) moving from left to right at a uniform speed. The pictures illustrated in each of FIGS. 7A and 7B represent images of the object taken at moments indicated by symbols “★” on a horizontal axis (that is, a time axis). The pictures illustrated in FIGS. 7A and 7B may correspond to the first data DATA_{—}1 or the second data DATA_{—}2.

In FIG. 7A, the image sensor 1000 may output the first data DATA_{—}1 on a first cycle time, or period, PER_{—}1a and may output the second data DATA_{—}2 on a second cycle time, or period, PER_{—}2. As illustrated in FIG. 7A, each of the pictures 10a, 11a, 12a, 13a, 14a and 15a generated from the first data DATA_{—}1 may have a relatively small size (or a relatively small amount of data), and the pictures 10a, 11a, 12a, 13a, 14a and 15a may sequentially generate on the first cycle time PER_{—}1a which is shorter than the second cycle time PER_{—}2. The pictures 10a, 11a, 12a, 13a, 14a and 15a generated from the first data DATA_{—}1 may be displayed on the viewfinder, may be used to execute an auto-focus function, or for any purpose that benefits from the quicker availability of image data, for example.

The picture 20a generated from the second data DATA_{—}2 may have a relatively large size (or a relatively large amount of data) and may be generated on the second cycle time PER_{—}2a which is longer than the first cycle time PER_{—}1. In accordance with principles of inventive concepts, the second data DATA_{—}2 may be generated without use of the electrical signals output from the first group of pixels 1101. As a result, the picture 20a may be incomplete, as illustrated in FIG. 7A. The image processor 2000 may synthesize, or combine, the first data DATA_{—}1 and the second data DATA_{—}2, which are taken at the same moment, to generate the second image data IMG_{—}2. That is, the image processor 2000 may combine the picture 10a having a relatively small size (that is, lower resolution, and a lesser amount of data) with the picture 20a having a relatively large size (that is, higher resolution, and a greater amount of data) to generate a complete picture 30a having a large size (that is, a high resolution image including data from both DATA_{—}1 and DATA_{—}2 data sets).

In FIG. 7B, in exemplary embodiments in accordance with principles of inventive concepts, the size (that is, the amount) of the first data DATA_{—}1 output from the image sensor 1000 may be changed. That is, the image sensor 1000 may generate the first data DATA_{—}1 output from all the first group of pixels 1101 on a second cycle time PER_{—}2b in order to obtain a complete picture 30b having a relatively large size and may then generate the first data DATA_{—}1 output from a portion of the first group of pixels 1101 on a first cycle time PER_{—}1b which is shorter than the second cycle time PER_{—}2b. In exemplary embodiments in accordance with principles of inventive concepts, the first data DATA_{—}1 output on the first cycle time PER_{—}1b may correspond to the electrical signals output from a portion of the first group of pixels 1101. For example, the first data DATA_{—}1 output on the first cycle time PER_{—}1b may correspond to the output signals of the first group of pixels 1101 located in every other row (for example, in odd-numbered rows or in even-numbered rows) of the pixel array 1100, in every third rows, in every fourth rows or the like.

The picture 10b may have a larger size than each of the pictures 11b˜17b. As a result, the time TIME_{—}1b required to generate the picture 10b may be longer than the first cycle time PER_{—}1b.

Referring to FIGS. 2 and 7B, in exemplary embodiments in accordance with principles of inventive concepts, the controller 1230 of the image sensor 1000 may control the first row driver 1211 such that the first read circuit 1221 sequentially receives the electrical signals output from all the first group of pixels 1101 on the second cycle time PER_{—}2b. In addition, the controller 1230 may control the first row driver 1211 such that the first read circuit 1221 sequentially receives the electrical signals output from a portion of among the first group of pixels 1101 on the first cycle time PER_{—}1b. These operations of the controller 1230 may be executed in response to the command signal CMD output from the image processor 2000 (see FIG. 1 or 6), for example.

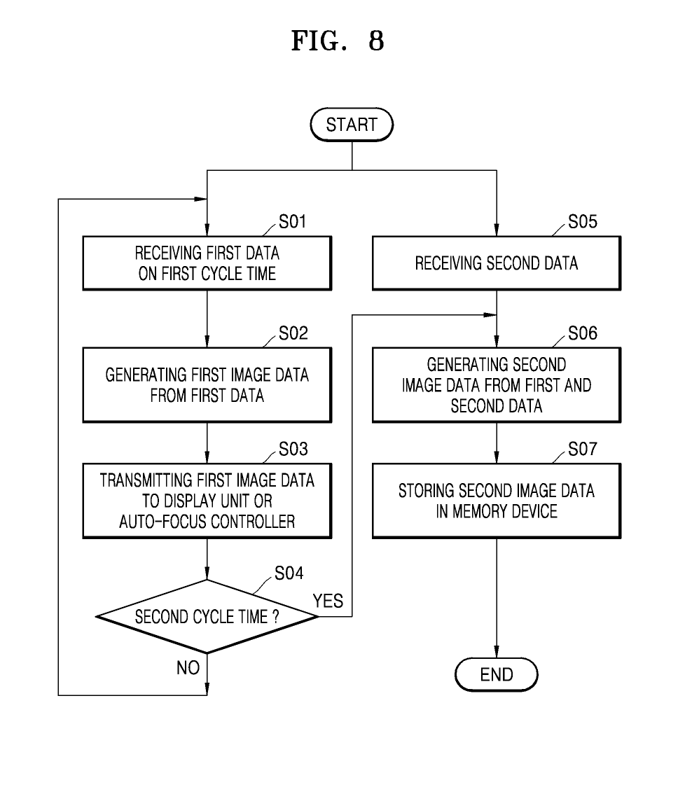

FIG. 8 is a flowchart illustrating an exemplary embodiment of the operation of an image processor in accordance with principles of inventive concepts. Specifically, FIG. 8 illustrates an operation of the image processor 2000 during the second cycle time. As described above, the image processor 2000 may receive the first and second data DATA_{—}1 and DATA_{—}2 output from the image sensor 1000 and may process the first and second data DATA_{—}1 and DATA_{—}2 to generate the first and second image data IMG_{—}1 and IMG-2.

In exemplary embodiments in accordance with principles of inventive concepts, the image processor 2000 may receive the first data DATA_{—}1 output from the image sensor 1000 on the first cycle time (step S01). In accordance with principles of inventive concepts, the image processor 2000 may also receive the second data DATA_{—}2 output from the image sensor 1000 (step S05). The first and second data DATA_{—}1 and DATA_{—}2 may be independently or simultaneously input to the image processor 2000. As described above, the image sensor 1000 may include the first and second drivers 1211 and 1212 that independently operate and the first and second read circuits 1221 and 1222 that independently operate. In addition, the image sensor 1000 may include the first terminal 1501 and the second terminal 1502 which are separately disposed. As a result, the first and second data DATA_{—}1 and DATA_{—}2 may be independently output from the image sensor 1000.

The image processor 2000 may generate the first image data IMG_{—}1 from the first data DATA_{—}1 (step S02). The first image data IMG_{—}1 may provide a picture having a relatively small size as compared with the second image data IMG_{—}2. The image processor 2000 may output the first image data IMG_{—}1 and may transmit the first image data IMG_{—}1 to the display unit 3000 or to the auto-focus controller 4000 (step S03). The display unit 3000 may display an image corresponding to the first image data IMG_{—}1, and the auto-focus controller 4000 may optimize the focus of the image using the first image data IMG_{—}1.

In accordance with principles of inventive concepts, image processor 2000 may compare the total time of the step S01 with the second cycle time (step S04). If the total time of the step S01 is equal to or greater than the second cycle time, the image processor 2000 may synthesize the first data DATA_{—}1 and the second data DATA_{—}2, which are simultaneously input to the image processor 2000 on the second cycle time, to generate the second image data IMG_{—}2 (step S06). That is, the second image data IMG_{—}2 may correspond to image data which are generated from the electrical signals output from all the pixels 1101 and 1102 included in the pixel array 1100. The image processor 2000 may store the second image data IMG_{—}2 in the memory device 5000.

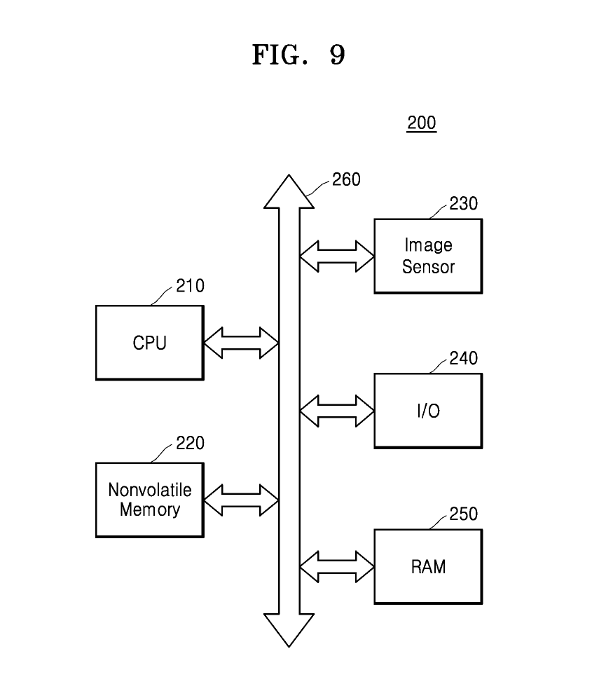

FIG. 9 is a block diagram illustrating a system 200 including an image sensor in accordance with principles of inventive concepts. The system 200 may be one of a computer system, a camera system, a scanner, an automobile navigator, a video phone, a security system, or a movement detection system, for example.

Referring to FIG. 9, the system 200 may include a central processing unit (CPU) (or a processor) 210, a nonvolatile memory 220, an image sensor 230, an input/output (I/O) device 240 and a random access memory (RAM) 250. The CPU 210 may communicate with the nonvolatile memory 220, the image sensor 230, the I/O device 240 and the RAM 250 through a bus 260. The image sensor 230 may be realized using a separate semiconductor chip or a single semiconductor chip combined with the CPU 210, for example. The image sensor 230 of the system 200 illustrated in FIG. 9 may include the first and second group of pixels 1101 and 1102, the first and second row drivers 1211 and 1212, the first and second read circuits 1221 and 1222, the controller 1230, and the first and second terminals 1501 and 1502 which are described with reference to previous exemplary embodiments. That is, the first and second row drivers 1211 and 1212 may independently operate, and the first and second read circuits 1221 and 1222 may also independently operate. As a result, the first group of pixels 1101 and the second group of pixels 1102 may be independently controlled and the first data DATA_{—}1 generated from the first group of pixels 1101 and the second data DATA_{—}2 generated from the second group of pixels 1102 may be independently output from the image sensor 230 through the first terminal 1501 and the second terminal 1502, respectively. The first data DATA_{—}1 may be output more quickly than the second data DATA_{—}2 to be displayed or to be used in an auto-focus function, for example.

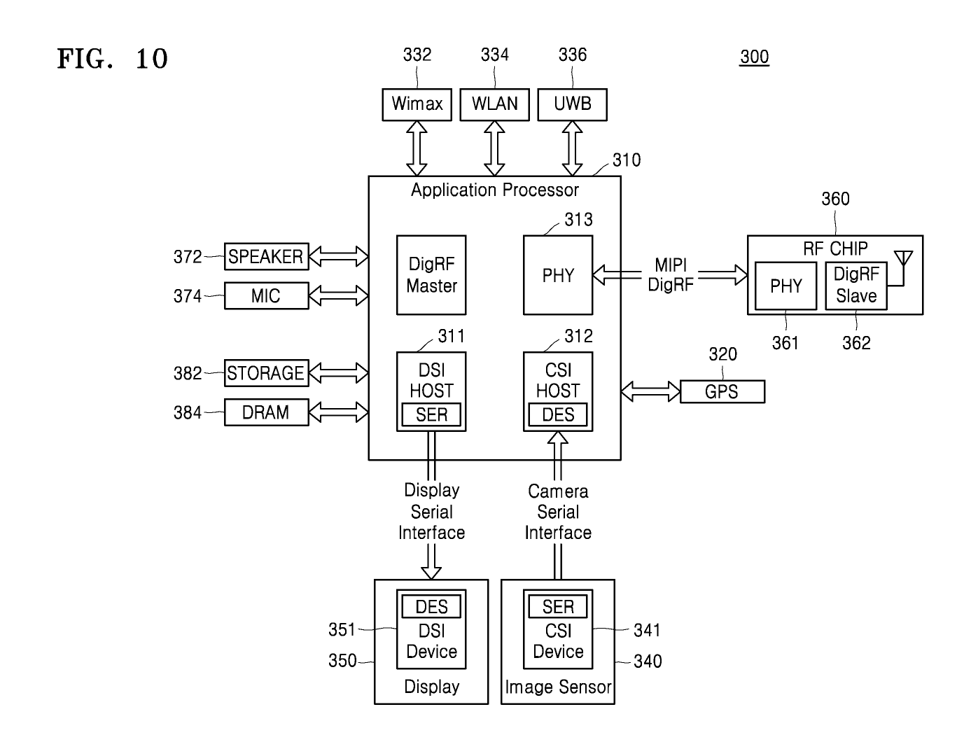

FIG. 10 is a block diagram of an electronic system 300 including an image sensor 340 in accordance with principles of inventive concepts. Referring to FIG. 10, the electronic system 300 may be a data processing system that can use or support a mobile industrial processor interface (MIPI). For example, the electronic system 300 may be a mobile phone, a personal digital assistant (PDA), a portable multimedia player (PMP) or a smart phone. The electronic system 300 may include an application processor 310, an image sensor 340 and a display unit 350.

A camera serial interface (CSI) host 312 in the application processor 310 may communicate with a CSI device 341 in the image sensor 340 through a CSI. In such a case, the CSI host 312 may be configured to include an optical deserializer and the CSI device 341 may be configured to include an optical serializer.

A display serial interface (DSI) host 311 in the application processor 310 may communicate with a DSI device 351 in the display unit 350 through a DSI. In such a case, the DSI host 311 may be configured to include an optical serializer and the DSI device 351 may be configured to include an optical deserializer.

The electronic system 300 may further include a radio frequency (RF) chip 360 that can communicate with the application processor 310. A physical layer (PHY) device 313 in the application processor 310 may perform data communication with a PHY device 361 in the RF chip 360 according to a MIPI DigRF.

The electronic system 300 may further include a global positioning system (GPS) 320, a storage unit 382, a dynamic random access memory (DRAM) 384, a speaker 372 and a microphone (MIC) 374. The electronic system 300 may communicate with external systems using world interoperability for microwave access (WIMAX) 332, a wireless local area network (WLAN) 334, an ultra wide band (UWB) 336 or the like.

While inventive concepts have been shown and described with reference to exemplary embodiments thereof, it will be understood that various changes in form and details may be made therein without departing from the spirit and scope of inventive concepts.

1-20. (canceled)

21. An image sensor comprising:
a pixel array configured to include a first group of pixels and a second group of pixels;
a controller;
a first signal path connected to the first group of pixels;
a second signal path connected to the second group of pixels; and
a read circuit configured to receive signals detected by the first group of pixels through the first signal path in response to a first path selection signal received from the controller and to receive signals detected by the second group of pixels through the second signal path in response to a second path selection signal received from the controller.

22. The image sensor of claim 21, further comprising:
a first row driver configured to control the first group of pixels; and
a second row driver configured to control the second group of pixels,
wherein the read circuit comprises:
a first read circuit configured to receive signals detected by the first group of pixels through the first signal path and to output first data; and
a second read circuit configured to receive signals detected by the second group of pixels through the second signal path and to output second data,
wherein the controller is configured to control the first and second row drivers such that the signals detected by the first group of pixels are input to the first read circuit during a first cycle time and the signals detected by the second group of pixels are input to the second read circuit during a second cycle time.

23. The image sensor of claim 22, further comprising a first terminal and a second terminal,
wherein the first and second read circuits are electrically connected to the first terminal and the second terminal, respectively;
wherein the controller is configured to control the first read circuit such that the first data are output through the first terminal during the first cycle time; and
wherein the controller is configured to control the second read circuit such that the second data are output through the second terminal during the second cycle time.

24. The image sensor of claim 22, wherein the controller is configured to control the first row driver such that the first read circuit receives signals detected by a portion of the first group of pixels through the first signal path during the first cycle time.

25. The image sensor of claim 24, wherein the portion of the first group of pixels is disposed in rows which are spaced apart from each other by a uniform distance;
wherein the second group of pixels is disposed between the first group of pixels.

26. The image sensor of claim 21,
wherein each of the first and second group of pixels includes a plurality of organic photoelectric conversion layers;
wherein the number of pixels included in the second group of pixels disposed between the first group of pixels along a row direction is equal to the number of pixels included in the second group of pixels disposed between the first group of pixels along a column direction.

27. The image sensor of claim 21,
wherein the pixel array further includes a color filter layer having a plurality of color filters which are arrayed in a Bayer pattern form; and
wherein the first group of pixels are two-dimensionally arrayed such that the color filters on respective ones of the first group of pixels are arrayed in the Bayer pattern form.

28. The image sensor of claim 22, wherein the controller is configured to set the first and second cycle times in response to a command signal supplied from an external device.

29. An image sensor comprising:
a plurality of pixel units which are two-dimensionally disposed in a matrix direction, and configured to include a first group of pixels and a second group of pixels;
a first signal path connected to the first group of pixels;
a second signal path connected to the second group of pixels; and
a control block comprising:
a first row driver configured to control the first group of pixels; and
a second row driver configured to control the second group of pixels,
wherein the number of pixels included in the first group of pixels is greater than the number of pixels included in the second group of pixels.

30. The image sensor of claim 29, wherein the control block further comprises:
a controller; and
a read circuit configured to receive signals detected by the first group of pixels through the first signal path in response to a first path selection signal received from the controller and to receive signals detected by the second group of pixels through the second signal path in response to a second path selection signal received from the controller.

31. The image sensor of claim 30,
wherein the read circuit comprises:
a first read circuit configured to receive signals detected by the first group of pixels through the first signal path and to output first data; and
a second read circuit configured to receive signals detected by the second group of pixels through the second signal path and to output second data.

32. The image sensor of claim 31,
wherein the controller is configured to control the first and second row drivers such that the signals detected by the first group of pixels are input to the first read circuit during a first cycle time and the signals detected by the second group of pixels are input to the second read circuit during a second cycle time.

33. The image sensor of claim 29, further comprising:
a first terminal; and
a second terminal,
wherein the control block is configured to output first data generated from signals detected by the first group of pixels through the first terminal and configured to output second data generated from signals detected by the second group of pixels through the second terminal.

34. A portable electronic device comprising:
an application processor; and
an image sensor configured to generate image data, the image sensor comprising:
a plurality of pixel units which are two-dimensionally disposed in a matrix direction, and configured to include a first group of pixels and a second group of pixels;
a first signal path connected to the first group of pixels;
a second signal path connected to the second group of pixels;
a first row driver configured to control the first group of pixels;
a second row driver configured to control the second group of pixels;
a first terminal;
a second terminal; and
a control block configured to output first data generated from signals detected by the first group of pixels through the first terminal and configured to output second data generated from signals detected by the second group of pixels through the second terminal,
wherein the number of pixels included in the first group of pixels is greater than the number of pixels included in the second group of pixels.

35. The portable electronic device of claim 34, further comprising:
an image processor connected with the image sensor,
wherein the image processor is configured to receive the first data during a first cycle time and the second data during a second cycle time and is configured to generate first image data from the first data.

36. The portable electronic device of claim 35, wherein the image processor synthesizes the first and second data to generate second image data during the second cycle time.

37. The portable electronic device of claim 36, further comprising a memory device,
wherein the image processor stores the second image data in the memory device.

38. The portable electronic device of claim 35, further comprising a viewfinder,
wherein the viewfinder displays an image generated from the first image data during the first cycle time.

39. The portable electronic device of claim 36,
wherein the size of the first image data is smaller than the second image data.

40. The portable electronic device of claim 35, wherein the image processor is configured to generate a command signal for setting the first and second cycle times and to apply the command signal to the image sensor; and
wherein the control block is configured to output the first data during the first cycle time in response to the command signal and to output the second data during the second cycle time in response to the command signal.
